(19) United States
(12) Patent Application Publication
(10) Pub. No.: US 2025/0292154 A1
(43) Pub. Date: Sep. 18, 2025

(54) MACHINE LEARNING TECHNIQUES FOR STOPPAGE TIME PREDICTION IN SOCCER

(71) Applicant: STATS LLC, Chicago, IL (US)

(72) Inventors: Nils Sebastiaan Mackay, Amsterdam (NL); Hayley REDGATE, Sandhurst (GB); Daniele FORONI, Chicago, IL (US); Daniel Richard DINSDALE, London (GB)

(73) Assignee: Stats LLC, Chicago, IL (US)

(21) Appl. No.: 19/056,401

(22) Filed: Feb. 18, 2025

Related U.S. Application Data
(60) Provisional application No. 63/566,657, filed on Mar. 18, 2024.

(51) Int. Cl. G06N 20/00; A63B 71/06

(52) U.S. Cl. CPC G06N 20/00; A63B 71/0686

(57) ABSTRACT

Techniques for method for using machine learning to predict stoppage time are disclosed. In an example, a method includes accessing, in real time, delay data from a sporting event. The delay data may be categorized by a type of delay. The method further includes generating, from the delay data, a linear regression. The method further includes providing, to a neural network, the linear regression and environmental data. The neural network is trained to predict an estimated stoppage time. The method further includes receiving, from the neural network, a predicted amount of stoppage time. The method further includes outputting the predicted amount of stoppage time.

### CROSS-REFERENCE TO RELATED APPLICATIONS

This application claims priority under 35 U.S.C. § 119 (e) to Provisional U.S. Patent Application No. 63/566,657, filed Mar. 18, 2024, the disclosure of which is hereby incorporated by reference in its entirety.

### TECHNICAL FIELD

Various aspects of the present disclosure relate generally to machine learning for sports applications and in particular to machine learning techniques for predicting stoppage time in soccer.

### BACKGROUND

Unlike many sports, soccer does not stop the game clock whilst a match is not in play. Injuries, contentious decisions, and video reviews, amongst many others, can cause temporary pauses in play. To account for these in-game stoppages, the referees assign an extra set of minutes known as stoppage time, to be played after the required minutes are up at the end of each period.

As such, being able to accurately predict the number of minutes added for stoppage time is vital part of in-game modelling for any other soccer metric, such as number of goals, number of passes, etc.

Unless otherwise indicated herein, the materials described in this section are not prior art to the claims in this application and are not admitted to be prior art, or suggestions of the prior art, by inclusion in this section.

### SUMMARY OF THE DISCLOSURE

In some aspects, the techniques described herein relate to a method for using machine learning to predict stoppage time in a sporting event, the method including: accessing, in real time, delay data from a sporting event, wherein the delay data is categorized by a type of delay; generating, from the delay data, a linear regression; providing, to a machine learning model, the linear regression and environmental data, wherein the machine learning model is trained to predict an estimated stoppage time; receiving, from the machine learning model, a predicted amount of stoppage time; and outputting the predicted amount of stoppage time.

In some aspects, the techniques described herein relate to a method, further including: generating, from the delay data, an additional linear regression associated with an actual stoppage time; providing, to an additional machine learning model, the additional linear regression, the environmental data, and the predicted amount of stoppage time, wherein the additional machine learning model is trained to predict an additional stoppage time; receiving, from the additional machine learning model, an additional predicted amount of increased stoppage time; and outputting the predicted amount of stoppage time.

In some aspects, the techniques described herein relate to a method, further including: accessing an indication of a start of stoppage time associated with the sporting event and an announced stoppage time; generating, from the delay data, an additional linear regression associated with the announced stoppage time; providing, to an additional machine learning model, the additional linear regression, the environmental data, and the announced stoppage time, wherein the additional machine learning model is trained to predict an additional stoppage time; receiving, from the additional machine learning model, an additional predicted amount of increased stoppage time; and outputting the predicted amount of stoppage time.

In some aspects, the techniques described herein relate to a method, wherein the delay data includes a plurality of delays, each of the plurality of delays having a respective type, the method further including categorizing the delay data by the type of delay and organizing the plurality of delays by type.

In some aspects, the techniques described herein relate to a method, wherein the delay data includes delays associated with events including one or more of: an offside pass, a free kick, an out, a corner, a goal, an issuance of a card, a start delay, and a provoking of an offside.

In some aspects, the techniques described herein relate to a method, wherein the environmental data includes a mean stoppage time of stoppage times of multiple games within a tournament.

In some aspects, the techniques described herein relate to a method, further including generating the environmental data, the generating including: accessing a plurality of data elements, each data element representing a stoppage time associated with a respective game at a respective point within the tournament; and calculating the mean stoppage time across the plurality of data elements by using a Bayesian approach.

In some aspects, the techniques described herein relate to a method, further including deriving, from the predicted amount of stoppage time, one or more of an estimated number of goals or passes associated with the sporting event.

In some aspects, the techniques described herein relate to a method for using machine learning to predict additional stoppage time, the method including: accessing an indication of a start of stoppage time associated with a sporting event and an announced stoppage time; accessing, in real time, delay data associated with the announced stoppage time, wherein the delay data is categorized by a type of delay; generating, from the delay data, a linear regression; providing, to a machine learning model, the linear regression, the announced stoppage time, and environmental data associated with the stoppage time; receiving, from the machine learning model, a predicted additional stoppage time; and outputting the predicted additional stoppage time.

In some aspects, the techniques described herein relate to a method, wherein the delay data includes a plurality of delays, each of the plurality of delays having a respective type, the method further including categorizing the delay data by the type of delay and organizing the plurality of delays by type.

In some aspects, the techniques described herein relate to a method, wherein the environmental data includes a mean stoppage time of stoppage times of multiple games within a tournament.

In some aspects, the techniques described herein relate to a method, further including generating the environmental data, the generating including: accessing a plurality of data elements, each data element representing a stoppage time associated with a respective game at a respective point within the tournament; and calculating the mean stoppage time across the plurality of data elements by using a Bayesian approach.

In some aspects, the techniques described herein relate to a method, further including deriving, from the predicted additional stoppage time, one or more of an estimated number of goals or passes associated with the sporting event.

In some aspects, the techniques described herein relate to a system for using machine learning to predict stoppage time in a sporting event, the system including: a non-transitory computer readable medium configured to store processor-readable instructions; and a processor operatively connected to the non-transitory computer readable medium, and configured to execute the instructions to perform operations including: accessing, in real time, delay data from the sporting event, wherein the delay data is categorized by a type of delay; generating, from the delay data, a linear regression; providing, to a machine learning model, the linear regression and environmental data, wherein the machine learning model is trained to predict an estimated stoppage time; receiving, from the machine learning model, a predicted amount of stoppage time; and outputting the predicted amount of stoppage time.

In some aspects, the techniques described herein relate to a system, wherein the processor is configured to execute additional operations including: generating, from the delay data, an additional linear regression associated with an actual stoppage time; providing, to an additional machine learning model, the additional linear regression, the environmental data, and the predicted amount of stoppage time, wherein the additional machine learning model is trained to predict an additional stoppage time; receiving, from the additional machine learning model, an additional predicted amount of increased stoppage time; and outputting the predicted amount of stoppage time.

In some aspects, the techniques described herein relate to a system, wherein the processor is configured to execute additional operations including: accessing an indication of a start of stoppage time associated with a sporting event and a announced stoppage time; generating, from the delay data, an additional linear regression associated with the announced stoppage time; providing, to an additional machine learning model, the additional linear regression, the environmental data, and the announced stoppage time, wherein the additional machine learning model is trained to predict an additional stoppage time; receiving, from the additional machine learning model, an additional predicted amount of increased stoppage time; and outputting the predicted amount of stoppage time.

In some aspects, the techniques described herein relate to a system, wherein the delay data includes a plurality of delays, each of the plurality of delays having a respective type and wherein the processor is configured to execute additional operations including categorizing the delay data by the type of delay and organizing the plurality of delays by type.

In some aspects, the techniques described herein relate to a system, wherein the environmental data includes a mean stoppage time of stoppage times of multiple games within a tournament.

In some aspects, the techniques described herein relate to a system, wherein the processor is configured to execute additional operations including generating the environmental data, the generating including: accessing a plurality of data elements, each data element representing a stoppage time associated with a respective game at a respective point within the tournament; and calculating the mean stoppage time across the plurality of data elements by using a Bayesian approach.

In some aspects, the techniques described herein relate to a system, wherein the processor is configured to execute additional operations including deriving, from the predicted amount of stoppage time, one or more of an estimated number of goals or passes associated with the sporting event.

Additional objects and advantages of the disclosed aspects will be set forth in part in the description that follows, and in part will be apparent from the description, or may be learned by practice of the disclosed aspects. The objects and advantages of the disclosed aspects will be realized and attained by means of the elements and combinations particularly pointed out in the appended claims.

It is to be understood that both the foregoing general description and the following detailed description are exemplary and explanatory only and are not restrictive of the disclosed aspects, as claimed.

### BRIEF DESCRIPTION OF THE DRAWINGS

The accompanying drawings, which are incorporated in and constitute a part of this specification, illustrate various exemplary aspects and together with the description, serve to explain the principles of the disclosed aspects.

FIG. 1 is a block diagram of an exemplary tracking and analytics environment, in accordance with an aspect.

FIG. 2 is a block diagram of an exemplary stoppage time prediction system, in accordance with an aspect.

FIG. 3 is a flow chart of an exemplary method for additional stoppage time prediction, in accordance with an aspect.

FIG. 4 is a flow chart of an exemplary method for stoppage time prediction, in accordance with an aspect.

FIG. 5 depicts estimations of a delay time for specific delay types, in accordance with an aspect.

FIG. 6 depicts examples of a Bayesian model for updating stoppage time for various sporting events, in accordance with an aspect.

FIG. 7 depicts data relating to calibration of a machine learning model for stoppage time prediction, in accordance with an aspect.

FIG. 8 depicts model and benchmark information for a machine learning model for stoppage time prediction, in accordance with an aspect.

FIG. 9 depicts calibration information of a machine learning model for additional stoppage time prediction, in accordance with an aspect.

FIG. 10 depicts model and benchmark information for a machine learning model for additional stoppage time prediction, in accordance with an aspect.

FIG. 11 depicts a flow diagram for training a machine learning model, in accordance with an aspect.

FIG. 12 depicts an example of a computing device, in accordance with an aspect.

Notably, for simplicity and clarity of illustration, certain aspects of the figures depict the general configuration of the various embodiments. Descriptions and details of well-known features and techniques may be omitted to avoid unnecessarily obscuring other features. Elements in the figures are not necessarily drawn to scale; the dimensions of some features may be exaggerated relative to other elements to improve understanding of the example embodiments.

### DETAILED DESCRIPTION OF ASPECTS

Various aspects of the present disclosure relate generally to techniques for machine learning for sports applications. For instance, certain aspects relate to machine learning techniques for predicting stoppage time in soccer. As discussed herein, certain aspects use a dual-machine learning model approach with a first model to predict an amount stoppage time for a match and a second model to predict an amount of additional stoppage time that will be added while the match is in stoppage time.

As discussed above, soccer, unlike other sports, does not stop the play clock when a match is not in play. While a game may stop for a foul or a goal, for example, the clock does not. To account for these in-game stoppages, the referees assign an extra set of minutes known as stoppage time. A round number of added minutes, usually between one minute and six minutes, is announced shortly before the 45-minute and 90-minute mark in the first and second halves of the game respectively. Stoppage time can help prevent a winning team from protecting their lead by running down the clock.

The referee may use their discretion in adding time, which can add uncertainty. In general, allowance is made for substitutions, assessment of injuries to players, removal of injured players, wasting time, goal celebrations, and other events. Stoppage time is played after the required minutes are up at the end of each period of play. The game will continue for a minimum of the added minutes until the match ends.

But the unpredictability of stoppage time affects an ability to perform accurate downstream sports analytics, e.g., deriving additional data based on stoppage time. More specifically, an ability of systems to accurately predict other soccer metrics may be impacted by stoppage time due to additional goals scored or key players being injured. For example, predicting the winner of a match currently 0-0 after eighty minutes can vary substantially based on expected stoppage time minutes. If an expected stoppage time is one minute, then there are only approximately eleven minutes to determine a winner. By contrast, if the expected stoppage time is ten minutes, then there are approximately twenty minutes to determine the winner. The more time left, the more game play and therefore, the more events that could take place in the remaining time.

But predictions of a stoppage time can be difficult for many reasons including environmental factors. For example, different leagues and countries may have different policies and procedures on how to correct for time loss. Also, video review systems can cause large delays in some leagues. Prior solutions used incomplete modeling and consequently were not able to accurately predict a stoppage time or used models that were limited to a particular league. Accordingly, accurate predictions of the effects of environmental features becomes increasingly helpful.

Disclosed techniques overcome these deficiencies by using a unique model architecture and with pre-model analysis. For example, disclosed techniques leverage machine learning in conjunction with linear regressions of real time game delay data and environmental data such as league data. In so doing, performance and accuracy of the resulting system is improved relative to previous solutions. For instance, by leveraging environmental data, disclosed solutions can account for referee discretion (such as accounting differently for a certain type of event) or league differences (e.g., world cup versus national leagues). Disclosed techniques can also account for additional delays that occur during stoppage time and predict an additional stoppage time that will be added once the stoppage has begun. Such predictions can be made multiple times, for example, once before the end of the first half and a second time before the end of the second half.

As used herein, a “machine learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine learning model is generally trained using training data, e.g., experiential data and/or samples of input data, which are fed into the model to establish, tune, or modify one or more aspects of the model, e.g., the weights, biases, criteria for forming classifications or clusters, or the like. Aspects of a machine learning model may operate on an input linearly, in parallel, via a network (e.g., a neural network), or via any suitable configuration.

The execution of the machine learning model may include deployment of one or more machine learning techniques, such as linear regression, logistic regression, random forest, gradient boosted machine (GBM), deep learning, computer vision, natural language processing, Bayesian models, and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

While several of the examples herein involve certain types of machine learning, disclosed techniques may be adapted to any suitable type of machine learning. It should also be understood that the examples above are illustrative only. The techniques and technologies of this disclosure may be adapted to any suitable activity.

While soccer and various aspects relating to soccer (e.g., a predicted total number of passes by a team during a game) are described in the present aspects as illustrative examples, the present aspects are not limited to such examples. For example, the present aspects can be implemented for other sports or activities, for which game time can be increased.

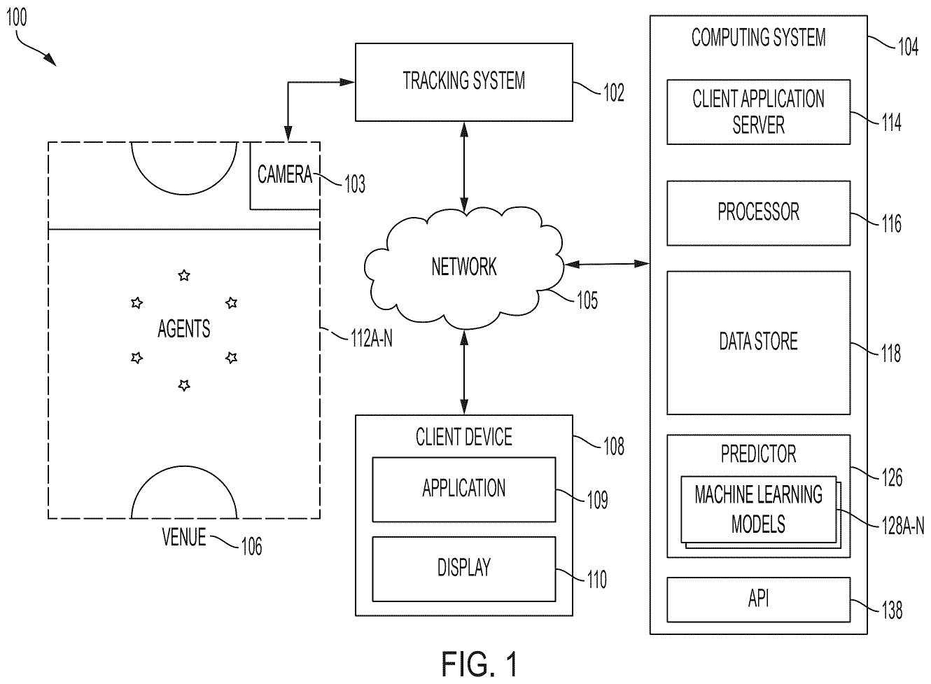

FIG. 1 is a block diagram illustrating a tracking and analytics environment 100, according to example aspects. Environment 100 includes tracking system 102, computing system 104, and client device 108 connected via network 105. In the example depicted, tracking system 102 obtains various measurements of game play, and transmits the measurements across network 105 to computing system 104, where the measurements can be used in conjunction with one or more machine learning models. The machine learning models can be employed to predict stoppage time in soccer matches.

Tracking system 102 is be positioned in, adjacent to, in communication with, or near a venue 106. Non-limiting examples of venue 106 include stadiums, fields, pitches, and courts. Venue 106 includes agents 112A-N (e.g., players). Tracking system 102 may be configured to record the motions and actions of agents 112A-N on the playing surface, as well as one or more other objects of relevance (e.g., ball, referees, etc.). Although environment 100 depicts agents 112A-N generally as players, it will be understood that in accordance with certain implementations, agents 112A-N may correspond to players, objects, markers, and/or the like.

In some aspects, tracking system 102 may be an optically-based system using, for example, using camera 103. While one camera is depicted, additional cameras are possible. For example, a system of six stationary, calibrated cameras, which project the three-dimensional locations of players and the ball onto a two-dimensional overhead view of the court may be used.

In another example, a mix of stationary and non-stationary cameras may be used to capture motions of all agents 112A-N on the playing surface as well as one or more objects or relevance. Utilization of such tracking system (e.g., tracking system 102) may result in many different camera views of the court (e.g., high sideline view, free-throw line view, huddle view, face-off view, end zone view, etc.). In some aspects, tracking system 102 may be used for a broadcast feed of a given match. In such aspects, each frame of the broadcast feed may be stored in a game file. In some aspects, the game file may further be augmented with other event information corresponding to event data, such as, but not limited to, game event information (pass, made shot, turnover, etc.) and context information (current score, time remaining, etc.).

In some aspects, a game file may include ratings data, standings data, statistics, and/or odds. In some aspects, a game file may include one or more match data types. A match data type may include, but is not limited to, position data (e.g., player position, object position, etc.) change data (e.g., changes in position, changes in players, changes in objects, etc.), trend data (e.g., player trends, position trends, object trends, team trends, etc.), play data, etc. A game file may be a single game file or may be segmented (e.g., grouped by one or more data type, grouped by one or more players, grouped by one or more teams, etc.).

In some embodiments, tracking system 102 may be used for a broadcast feed of a given match. For example, tracking system 102 may be used to generate game files to facilitate a broadcast feed of a given match. In such embodiments, each frame of the broadcast feed may be stored in a game file. A broadcast feed may be a feed that is formatted to be broadcast over one or more channels (e.g., broadcast channels, internet based channels, etc.). A game file may be converted from a first format (e.g., a format output by the one or more cameras or a different format than the format output by the one or more cameras) and may be converted into a second format (e.g., for broadcast transmission).

In some embodiments, game file may further be augmented with other event information corresponding to event data, such as, but not limited to, game event information (pass, made shot, turnover, etc.) and context information (current score, time remaining, etc.). According to embodiments, event data may be generated manually or may be generated by a computing system in real time (e.g., within approximately 30 seconds of an event occurring), as discussed herein. A computing system may generate the event data by, for example, analyzing tracking data (e.g., from tracking system 102), and/or one or more other data types such as a video feed, excitement data, an audio feed, etc. The computing system may utilize a machine learning model to determine when given tracking data or changes in tracking data (e.g., given player movements, object movements, changes in the same, crowd movements, etc.) correspond to an event (e.g., a scoring event, a penalty event, a possession based event, play type event, etc.). Event data may be automatically identified using a machine learning trained to receive, as an input, a game file or a subset thereof and output game information and/or context information based on the input. The machine learning model may be trained using supervised, semi-supervised, or unsupervised learning, in accordance with the techniques disclosed herein. The machine learning model may be trained by analyzing training data using one or more machine learning algorithms, as disclosed herein. The training data may include game files or simulated game files from historical games, simulated games, and/or the like and may include tagged and/or untagged data.

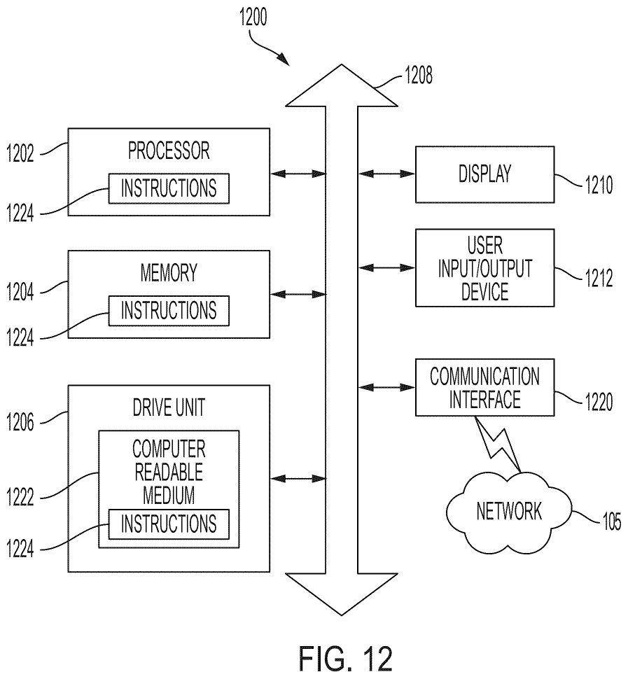

Tracking system 102 may be configured to communicate with computing system 104 via network 105. Computing system 104 may be configured to manage and analyze the data captured by tracking system 102. Computing system 104 may include a web client application server 114, a pre-processing agent 116, a data store 118, and a third-party Application Programming Interface (API) 138. An example of computing system 104 is depicted with respect to FIG. 12. In an example, tracking system 102 may be configured to provide computing system 104 with a broadcast stream of a game or event in real-time or near real-time via network 105. As an example, tracking system 102 may provide one or more game files in a first format (e.g., corresponding to a format based on the components of tracking system 102). Alternatively, or in addition, tracking system 102 or organization computing system 104 may convert the broadcast stream (e.g., game files) into a second format, from the first format. The second format may be based on the computing system 104. For example, the second format may be a format associated with data store 118.

Computing system 104 may be configured to process the broadcast stream of the game. Organization computing system 104 may include components shown in FIG. 1, as described herein, as well as one or more of a tracking data system, a play-by-play module, and/or padding module. A tracking data system, play-by-play module, padding module, and prediction system (including predictor 126) may be comprised of one or more software modules. The one or more software modules may be collections of code or instructions stored on a media (e.g., memory of computing system 104) that represent a series of machine instructions (e.g., program code) that implements one or more algorithmic steps. Such machine instructions may be the actual computer code the processor of organization computing system 104 interprets to implement the instructions or, alternatively, may be a higher level of coding of the instructions that is interpreted to obtain the actual computer code. The one or more software modules may also include one or more hardware components. One or more aspects of an example algorithm may be performed by the hardware components (e.g., circuitry) itself, rather than as a result of the instructions.

The tracking data system may be configured to receive broadcast data from tracking system 102 and generate tracking data from the broadcast data. In some embodiments, the tracking data system may apply an artificial intelligence and/or computer vision system configured to derive player-tracking data from broadcast video feeds.

To generate the tracking data from the broadcast data, the tracking data system may, for example, map pixels corresponding to each player and ball to dots and may transform the dots to a semantically meaningful event layer, which may be used to describe player attributes. For example, the tracking data system may be configured to ingest broadcast video received from tracking system 102. In some embodiments, the tracking data system may further categorize each frame of the broadcast video into trackable and non-trackable clips. In some embodiments, the tracking data system may further calibrate the moving camera based on the trackable and non-trackable clips. In some embodiments, the tracking data system may further detect players within each frame using skeleton tracking. In some embodiments, the tracking data system may further track and re-identify players over time. For example, the tracking data system may reidentify players who are not within a line of sight of a camera during a given frame. In some embodiments, the tracking data system may further detect and track an object across a plurality of frames. In some embodiments, the tracking data system may further utilize optical character recognition techniques. For example, the tracking data system may utilize optical character recognition techniques to extract score information and time remaining information from a digital scoreboard of each frame.

Such techniques assist in the tracking data system generating tracking data from the broadcast feed (e.g., broadcast video data). For example, the tracking data system may perform such processes to generate tracking data across thousands of possessions and/or broadcast frames. In addition to such process, computing system 104 may go beyond the generation of tracking data from broadcast video data. Instead, to provide descriptive analytics, as well as a useful feature representation for the prediction system, computing system 104 may be configured to map the tracking data to a semantic layer (e.g., events).

The tracking data system may be implemented using a machine learning model. The machine learning model may be trained using supervised, semi-supervised, or unsupervised learning, in accordance with the techniques disclosed herein. The machine learning model may be trained by analyzing training data using one or more machine learning algorithms, as disclosed herein. The training data may include game files or simulated game files from historical games, simulated games, historical or simulated feature representations, and/or the like and may include tagged and/or untagged data. The tagged data may include position information, movement information, object information, trends, agent identifiers, agent re-identifiers, etc.

A play-by-play module may be configured to receive play-by-play data from one or more third party systems. For example, the play-by-play module may receive a play-by-play feed corresponding to the broadcast video data. In some embodiments, the play-by-play data may be representative of human generated data based on events occurring within the game. Even though the goal of computer vision technology is to capture all data directly from the broadcast video stream, the referee, in some situations, is the ultimate decision maker in the successful outcome of an event. For example, in basketball, whether a basket is a 2-point shot or a 3-point shot (or is valid, a travel, defensive/offensive foul, etc.) is determined by the referee. As such, to capture these data points, the play-by-play module may utilize machine learning outputs and/or manually annotated data that may reflect the referee's ultimate adjudication. Such data may be referred to as the play-by-play feed.

To help identify events within the generated tracking data, the tracking data system may merge or align the play-by-play data with the raw generated tracking data (which may include the game and time fields). The tracking data system may utilize a fuzzy matching algorithm, which may combine play-by-play data, optical character recognition data (e.g., shot clock, score, time remaining, etc.), and play/ball positions (e.g., raw tracking data) to generate the aligned tracking data.

Once aligned, the tracking data system may be configured to perform various operations on the aligned tracking system. For example, the tracking data system may use the play-by-play data to refine the player and ball positions and precise frame of the end of possession events (e.g., shot/rebound location). In some embodiments, the tracking data system may further be configured to detect events, automatically, from the tracking data. In some embodiments, the tracking data system may further be configured to enhance the events with contextual information.

For automatic event detection, the tracking data system may include a neural network system trained to detect/refine various events in a sequential manner. For example, the tracking data system may include an actor-action attention neural network system to detect/refine one or more of: shots, scores, points, rebounds, passes, dribbles, penalties, fouls, and/or possessions. The tracking data system may further include a host of specialist event detectors trained to identify higher-level events. Exemplary higher-level events may include, but are not limited to, plays, transitions, presses, crosses, breakaways, post-ups, drives, isolations, ball-screens, offside, handoffs, off-ball-screens, and/or the like. In some embodiments, each of the specialist event detectors may be representative of a neural network, specially trained to identify a specific event type. More generally, such event detectors may utilize any type of detection approach. For example, the specialist event detectors may use a neural network approach or another machine learning classifier (e.g., random decision forest, SVM, logistic regression etc.).

While mapping the tracking data to events enables a player representation to be captured, to further build out the best possible player representation, the tracking data system may generate contextual information to enhance the detected events. Exemplary contextual information may include defensive matchup information (e.g., who is guarding who at each frame, defensive formations), as well as other defensive information such as coverages for ball-screens or presses.

As discussed herein, disclosed solutions leverage delay data to predict stoppage time. Delay data may be determined and/or received from an external device. For instance, occurrences of events during a match (e.g., a goal, or an assist), may be determined by tracking system 102 and stored in data store 118. Such a determination may be made based on a video stream such as a broadcast video stream (e.g., via TV or streaming) and/or an in-venue feed. In turn, the information is analyzed to determine an occurrence of an event and a type of event.

In some cases, a data stream prepared by a human observer may be used. For instance, a human observer may record when a goal occurs, and information such as the event type and time stamp (e.g., minutes into the game) may be entered into a data stream that is in turn used by systems disclosed herein.

Pre-processing agent 116 may be configured to process data retrieved from data store 118 or tracking system 102 prior to input to predictor 126.

Data store 118 may be configured to store different kinds of data, including sports-related data. In an example, data store 118 can store raw tracking data received from tracking system 102. The data store 118 can include historical game data, live data, and features. The historical game data 120 can include historical team and player data for one or more sporting events. Live data 112 can include data received from tracking system 102, e.g., in real time. Data store 118 may be configured to store one or more game files. Each game file may include video data of a given match (e.g., a game, a competition, a round, etc.) and/or may include tracking data generated by tracking system 102 or in response to data generated by tracking system 102. Video data may correspond to data for an ongoing match or data for a previous or historical match. For example, the video data may correspond to video frames captured by tracking system 102 (e.g., as a broadcast feed, an in-venue feed, etc.). In some aspects, the video data may correspond to broadcast data of a given match, in which case, the video data may correspond to video frames of the broadcast feed of a given match.

Feature vectors can be generated for a specific sporting event (e.g., a soccer match) or a combination of events. Feature vectors can include player and/or team features. For instance, feature vectors may include various live game data such as delays and associated causes (e.g., injuries, throw-ins), and/or environmental factors such as prior delays in matches within an associated league or with an particular referee.

Predictor 126 includes one or more machine learning models 128A-N. As discussed further herein, one or more of machine learning models 128A-N may be used to predict an amount of stoppage time in soccer matches. For instance, machine learning model 128A, or a “first” model, may predict an amount of stoppage time, and machine learning model 128B, or a “second” model, may predict an additional amount of stoppage time to be added above and beyond an initial stoppage time. Machine learning models 128A-N may be neural networks. In some cases, one or more of the machine learning models 128A-N are remotely hosted, for example on a remote server. Machine learning models 128A-N can be generative machine learning models.

In some cases, the machine learning models 128A-N require input of a prompt. As such, computing system 104 and/or predictor 126 can generate one or more prompts such that the output of the model is aligned with the request, query, or information included in the prompt. A prompt can include instructions to the model (e.g., task(s) to be performed, and style of output), data to be used (e.g., data from a particular team or a player), and/or any user preferences (e.g., style, tone, or length).

Client device 108 may be in communication with computing system 104 via network 105. Client device 108 may be operated by a user. For example, client device 108 may be a mobile device, a tablet, a desktop computer, or any computing system having the capabilities described herein. Users may include, but are not limited to, individuals such as, for example, subscribers, clients, prospective clients, or customers of an entity associated with computing system 104, such as individuals who have obtained, will obtain, or may obtain a product, service, or consultation from an entity associated with computing system 104.

Client device 108 may include one more applications 109. Application 109 may be representative of a web browser that allows access to a website or a stand-alone application. Client device 108 may access application 109 to access one or more functionalities of computing system 104. Client device 108 may communicate over network 105 to request a webpage, for example, from web client application server 114 of computing system 104. For example, client device 108 may be configured to execute application 109 to access content managed by web client application server 114. The content that is displayed to client device 108 may be transmitted from web client application server 114 to client device 108, and subsequently processed by application 109 for display through a graphical user interface (GUI) of client device 108.

Client device may include display 110. Examples of display 110 include, but are not limited to, computer displays, Light Emitting Diode (LED) displays, and so forth. Output or visualizations generated by application 109 can be displayed on display 110.

Functionality of sub-components illustrated within computing system 104 can be implemented in hardware, software, or some combination thereof. For example, software components may be collections of code or instructions stored on a media such as a non-transitory computer-readable medium (e.g., memory of computing system 104) that represent a series of machine instructions (e.g., program code) that implements one or more method operations. Such machine instructions may be the actual computer code the processor of computing system 104 interprets to implement the instructions or, alternatively, may be a higher level of coding of the instructions that is interpreted to obtain the actual computer code. The one or more software modules may also include one or more hardware components. Examples of components include processors, controllers, signal processors, neural network processors, and so forth.

Network 105 may be of any suitable type, including individual connections via the Internet, such as cellular or Wi-Fi networks. In some aspects, network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connection be encrypted or otherwise secured. In some aspects, however, the information being transmitted may be less personal, and therefore, the network connections may be selected for convenience over security.

Network 105 may include any type of computer networking arrangement used to exchange data or information. For example, network 105 may be the Internet, a private data network, virtual private network using a public network and/or other suitable connection(s) that enables components in tracking and analytics environment 100 to send and receive information between the components of tracking and analytics environment 100.

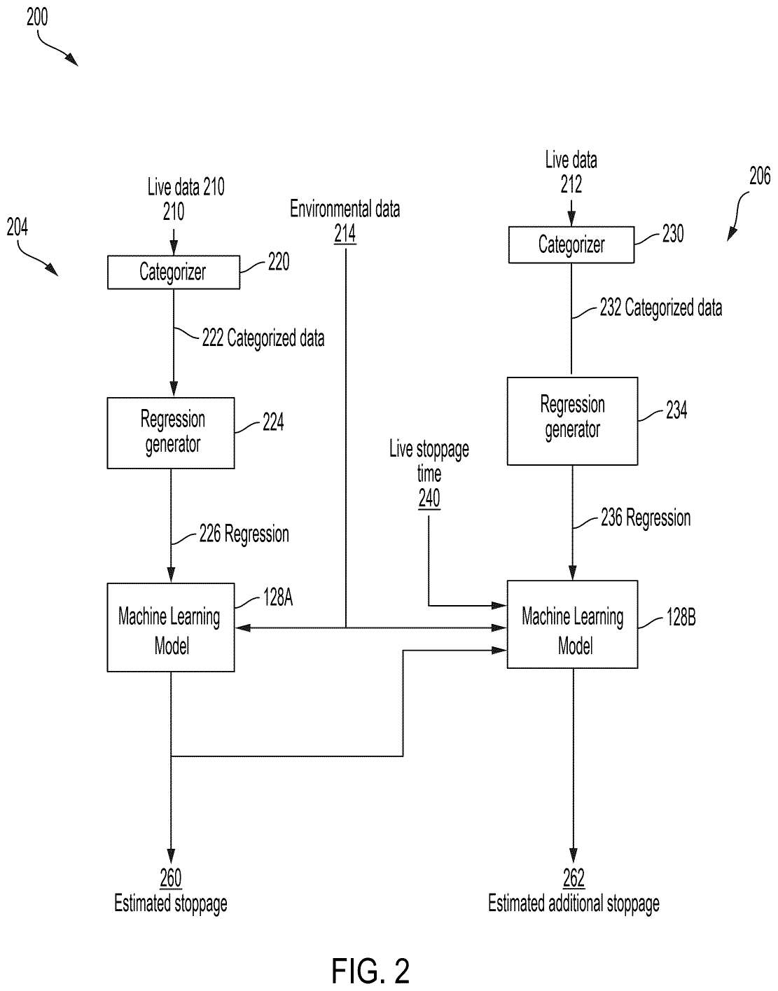

FIG. 2 is a block diagram of an exemplary stoppage time prediction system 200, in accordance with an aspect. As explained below, stoppage time prediction system 200 includes a first prediction path 204 and a second prediction path 206. According to one or more embodiments, first prediction path 204 may predict an estimated stoppage time based on live data 210 which may be in the form of tracking data and/or event data as disclosed herein. Second prediction path 206 may predict additional estimated stoppage time based on live data 210, where the second prediction path 206 predicts such estimated stoppage time after an official stoppage time has been announced. Accordingly, second prediction path 206 may be informed by the first prediction path 204 and may refine or update the estimate output by the first prediction path 204. For example, a second machine learning model 128B may be trained, in part, based on the output of first machine learning model 128A and based on one or more official stoppage times. As such, second machine learning model 128B may be trained to adjust for the types and durations of delays being implemented in a given sporting event, thereby making sporting event specific predictions.

First prediction path 204 employs a first machine learning model 128A to estimate a stoppage time for one or more periods of game play (e.g., halves). This estimated stoppage time may be provided and/or updated live (e.g., in real time) as a given match progresses. Second prediction path 206 employs a second machine learning model 128B to estimate an additional stoppage time that may be added during the stoppage time period for one or more periods of game play. This estimated additional stoppage time may be provided and/or updated live (e.g., in real time) as a given match progresses during stoppage time.

As explained below, to generate these predictions, each of first prediction path 204 and second prediction path 206 may independently access live data, environmental data, and/or other data. Each of first prediction path 204 and second prediction path 206 may include various functional blocks, each of which may be implemented in software, hardware, or a combination of both. In some examples, the other data may include event data and/or tracking data. As previously described, event data may be generated manually or may be generated by a computing system.

First prediction path 204 can predict an estimated stoppage time before stoppage time occurs in a game. First prediction path 204 includes categorizer 220, regression generator 224, and machine learning model 128A. In the example depicted, categorizer 220 receives live data 210, which may include events as they occur in a match. Examples of events may include goals, substitutions, yellow and red cards, and causes of delays. Such events may be determined using tracking data and/or event data as disclosed herein.

Categorizer 220 categorizes the data into categorized data 222. Categorizer 220 may categorize various delays occurring during a soccer match based on the live data 210. An event may be associated with a start of a delay, an end of a delay, or both. Examples of events that may be associated with a start of a delay include an offside pass, a free kick, an out, a corner, a goal, a video assistant referee (VAR) review, an issuance of a card, a start delay, and a provoking of an offside. Examples of events associated with an end of a delay can include an occurrence of a pass, miss, post, attempt saved, goals, and a referee drop ball, and an end. Other events are possible.

An impact of a particular delay to the soccer match can vary based on a type of delay or delay type. For example, stoppage time attributable to treatment of an injury may be over five minutes, whereas stoppage time attributable to other events may be less. As such, to predict accurately, an amount and length of every delay in the respective period are modeled.

In a more specific example, categorizer 220 receives live data 210, which can include data relating to one or more events occurring during the match. Categorizer 220 can output a list of delays for a specific period of time or window based on live data 210. Example attributes associated with each delay include but are not limited to: a duration of the delay in seconds, a list of event types that occurred during this delay, and/or a start time of the delay (minute and second of the match).

Each delay can have an associated start and/or end time. A goal is an event that can both start and end a delay. In the case of a penalty, once the penalty is awarded, a delay starts, and ends once the penalty is taken (and potentially scored). However, when the penalty is scored, a new delay immediately starts. This second delay only ends when the kick-off is taken (or the half is ended before that happens).

Categorizer 220 may group each delay into a specific delay group. Such a grouping improves the ability to estimate the effect of events in the particular delay group on the stoppage time. In general, the longer the delay, the larger the proportion of time that will be compensated. Certain delay types may be compensated more fairly in the game than others. In some cases, delays of a particular type can vary dramatically given the environment.

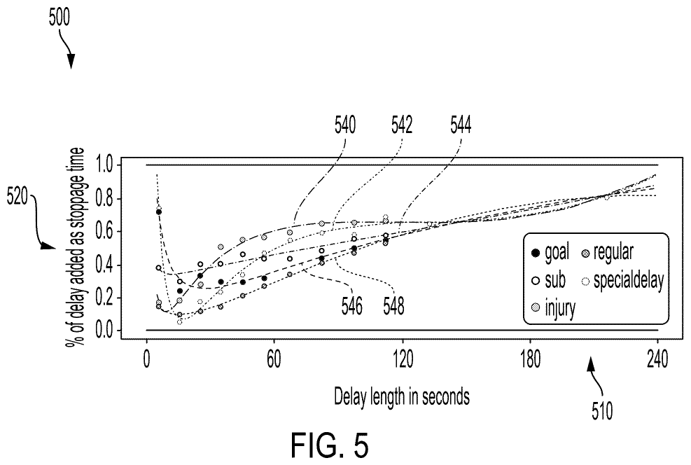

Accordingly, machine learning model 128A may adjust the effect of the delay based on the environment. For instance, a delay due to a goal may be one minute in a first league and two minutes in a second league, and so forth. FIG. 5 depicts examples of impacts of various delays. As can be seen, the delays may be grouped by length, by binning, or separating, into groups with roughly the same delay length. In an aspect, delays in different periods (e.g., halves) may be treated differently.

Returning to FIG. 2, in turn, categorized data 222 is provided to regression generator 224, which performs an initial linear regression of the categorized delays, outputting regression 226 that includes one or more proportions, each proportion representing a particular stoppage. The regression 226 is provided to machine learning model 128A in a form of a list of event features.

The machine learning approaches discussed herein leverage various environmental data to improve predictions of effects resulting from occurrences of various events. Environmental data 214 may include data relating to game environment (including, for example, league and referee specific information). Environmental data 214 may be provided to machine learning model 128A in the form of a feature vector.

Accordingly, environmental data 214 may be match-specific, league-specific, and/or period specific. For instance, an occurrence of an event in one situation may cause a first delay in a first match but a second, different, delay in a second match. For instance, in some league seasons, an average stoppage time given in the second half was only three minutes, whereas in other league seasons the average was almost eight minutes.

Regression 226 and environmental data 214 is provided to machine learning model 128A. In turn, machine learning model 128A generates estimated stoppage 260, which indicates an amount of time (e.g., minutes) of stoppage time before actual stoppage occurs in a game. Estimated stoppage 260 may be output to a client device such as client device 108 and/or provided to the second prediction path 206.

Machine learning model 128A may be trained before use and/or during use. For example, machine learning model 128A may be a regression feed-forward neural network trained using, for example, PyTorch™. Other models and/or training approaches are possible. Machine learning model 128A may include one or more generative machine learning models trained to output data based on the input data derived from various database records obtained from data store 118. The one or more models may be trained using historical or simulated sports data, historical or simulated preferences, historical or simulated environmental data, and/or the like. As further discussed herein, the one or more models may be iteratively trained based on updated (e.g., current) training data such as game data, environmental data, and/or a user.

Second prediction path 206, including machine learning model 128B may predict an additional amount of stoppage time that will be added above and beyond an initial stoppage time. To do so, machine learning model 128B may rely in part upon the estimated stoppage time from machine learning model 128A when an actual amount of stoppage time is unknown, e.g., before the amount of stoppage time is announced. By contrast, when the actual amount of stoppage time becomes known, machine learning model 128B relies instead upon the actual amount of stoppage time, for example, as indicated by a referee during the match.

As depicted, second prediction path 206 includes categorizer 230, regression generator 234, and model 128B. Second prediction path 206 can execute similar functions as first prediction path 204, as explained herein. In the example depicted, categorizer 230 receives live data 212, which may include, for example, events as they occur in a match. In some cases, live data 212 may be a subset of live data 210 for example, being limited to events that occur during stoppage time.

Categorizer 230 categorizes the data into categorized data 232. Categorizer 230 may perform similar functions as described above with respect to categorizer 220. In turn, categorized data 232, including delays, is provided to regression generator 234. As discussed, FIG. 5 depicts examples of impacts of various delays.

Regression generator 234 may perform similar functions as described above with respect to regression generator 224. Regression generator 234 performs an initial linear regression of the categorized delays, outputting regression 236.

Machine learning model 128B can receive regression 236 and/or environmental data 214. Before actual stoppage time is known, model 128B may receive estimated stoppage 260 as generated by model 128A. During stoppage time, model 128B may receive live stoppage time 240, as received from live data related to the game. Live stoppage time 240 represents a current value of the stoppage time thus far in a game. As discussed herein, machine learning model 128B may be retrained or refined based on the output(s) of machine learning model 128A. For example, machine learning model 128B may receive the output(s) of machine learning model 128 which may include estimated stoppage 260 and/or breakdowns of multiple stoppage times used to generate estimated stoppage 260. Machine learning model 128B may be retrained or refined, for example, based on differences between the received stoppage times from machine learning model 128A and the actual stoppage time such that machine learning model 128B is retrained or refined to account for the specific stoppage times implemented by officials in a given game. Accordingly, machine learning model 128B may be tailored, in real-time to account for how stoppage times are allocated in a live sporting event.

In turn, machine learning model 128B generates estimated stoppage 260 which indicates an amount of predicted time (e.g., minutes) of additional stoppage time that may be added to actual stoppage time. For instance, if three minutes of stoppage time is given in the second half, machine learning model 128B may calculate an amount of time that will actually be played beyond the initial three minutes. Additional models are possible.

Machine learning model 128B may be trained before use and/or during use, as disclosed herein. For example, machine learning model 128B may be a regression feed-forward neural network trained using, for example, PyTorch™. Other models and/or training approaches are possible.

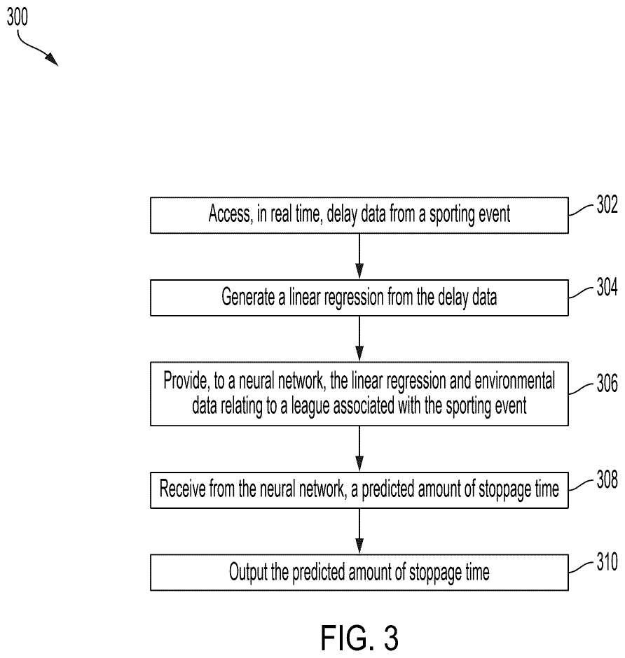

FIG. 3 is a flow chart of an exemplary method 300 for stoppage time prediction, in accordance with an aspect. Method 300 may be executed by components of the first prediction path 204.

Method 300 includes various operations, indicated by blocks. It will be appreciated that in some cases, not all operations are performed. For example, in some cases, some operations can be skipped. In some examples, operations can be performed multiple times, for example, in a loop. Other variations are possible.

At block 302, method 300 may involve accessing, in real time, delay data from a sporting event. Delay data can include multiple delays, each delay having a respective type. Delays are caused by occurrences of events, such as an offside pass, a free kick, an out, a corner, a goal, an issuance of a card, a start delay, or a provoking of an offside. Delay data may be determined based on actual or predicted events as determined based on tracking data and/or event data in accordance with techniques disclosed herein.

Categorizer 220 accesses live data 210. Categorizer 220 can categorize the delay data by the type of delay and organize the delays by type. Continuing the example, categorizer 220 generates categorized data 222 from live data 210. In an example, categorizer 220 may generate the categorized data 222 from the live data 210 as well as the event data. In some examples, categorizer 220 may generate the categorized data 222 from the event data.

At block 304, method 300 may involve creating a linear regression from the delay data. Continuing the example, regression generator 224 accesses categorized data 222 and generates a regression 226.

At block 306, method 300 may involve providing, to a neural network, the linear regression and environmental data relating to a league associated with the sporting event. The environmental data may include statistics such as mean, median, mode, and so forth, relating to stoppage time across multiple games within a tournament. Continuing the example, regression generator 224 provides the regression 226 to machine learning model 128A.

At block 308, method 300 may involve receiving, from the neural network, a predicted amount of stoppage time. Continuing the example, machine learning model 128A outputs a predicted amount of stoppage time.

In some cases, the predictions are floating point numbers that represent the expected number of seconds of stoppage that will be given in each period. These numbers will not necessarily be a multiple of sixty. For instance, a prediction could be 78.1, meaning on average 78.1 seconds of stoppage time is expected.

At block 310, method 300 may involve outputting the predicted amount of stoppage time. Continuing the example, stoppage time prediction system 200 may output estimated stoppage 260. Stoppage time prediction system 200 can output estimated stoppage 260 to a display or transmit the estimated stoppage 260 to another device or downstream entity. In an example, the output of the estimated stoppage 260 may be a report. In such an example, the report may include estimated stoppage 260 as well as a summary of the reasons for the estimated stoppage 260 based on the delay data and/or any other type of data such as tracking data or event data. As another example, one or more market predictions may be generated based on the estimated stoppage 260. The market predictions may be generated based on the estimated stoppage 260 and predicted events as determined in accordance with the techniques disclosed herein. The market predictions may include a numerical prediction of a sports event related value (e.g., score, passes, play types, scores by a player or team, etc.)

that is a likelihood of a given sporting event or events reaching or not reaching that value (e.g., whether a score will be above or below the market prediction value). As discussed above, stoppage time prediction system 200 may provide the predicted amount of stoppage time to another device such as client device 108.

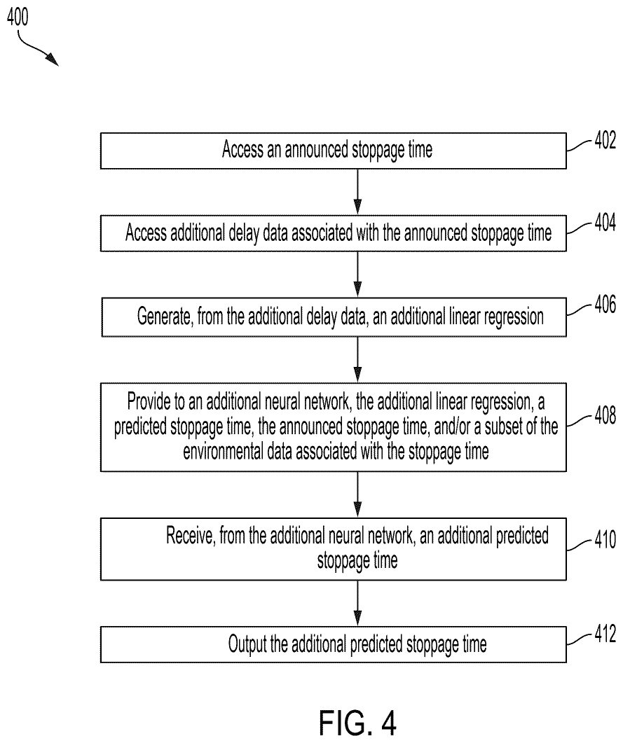

As discussed, in addition to predicting the number of added minutes assigned by the referee, certain aspects predict how much additional time will be played past the announced stoppage time. For example, just because 4 minutes of stoppage time is announced, it does not mean that the game must stop the moment that these 4 minutes are up. There could be further delays during stoppage time that increase how many minutes should be played. FIG. 4 depicts such one approach.

FIG. 4 is a flow chart of an exemplary method 400 for additional stoppage time prediction, in accordance with an aspect. Method 400 may be executed by components in second prediction path 206, before or during an actual stoppage time period.

Method 400 includes various operations, indicated by blocks. It will be appreciated that in some cases, not all operations are performed. For example, in some cases, some operations can be skipped. In some examples, operations can be performed multiple times, for example, in a loop. Other variations are possible.

At block 402, method 400 may involve accessing an announced stoppage time. For example, machine learning model 128B accesses live stoppage time 240, as may be indicated by a referee. In some cases, block 402 may not be performed, for instance, if the actual stoppage time is not yet known.

At block 404, method 400 may involve accessing additional delay data associated with the actual stoppage time. For example, categorizer 230 accesses live data 212, where live data 212 occurs during an actual stoppage. Categorizer 220 generates categorized data 232 from the live data 212. In some cases, live data 212 may be limited to events occurring during stoppage time. In an example, categorizer 230 may generate the categorized data 232 from the live data 212 as well as the event data. In some examples, categorizer 230 may generate the categorized data 232 from the event data.

At block 406, method 400 may involve generating, from the additional delay data, an additional linear regression. The additional linear regression being associated with the actual stoppage time. Continuing the example, regression generator 234 accesses categorized data 232 and generates a regression 236. At block 406, method 400 may perform substantially similar operations as discussed with respect to block 304 of method 300.

At block 408, method 400 may involve providing, to an additional neural network, the additional linear regression, the predicted stoppage time, the actual stoppage time, and/or a subset of the environmental data associated with the stoppage time. Continuing the example, regression generator 234 provides the regression 236, a predicted stoppage time (e.g., from machine learning model 128A), live stoppage time 240, and environmental data 214 to machine learning model 128B.

As discussed, machine learning model 128B may operate with a predicted stoppage time, e.g., as generated by machine learning model 128A until an actual stoppage time is known. When the actual stoppage time is known, then machine learning model 128B is provided the actual stoppage time (e.g., an on-field announcement by the referee) instead.

In some aspects, machine learning model 128B may be a regression feed-forward neural network trained using, for example, PyTorch™. Other models and/or training approaches are possible.

At block 410, method 400 may in involve receiving, from the additional neural network, an additional predicted stoppage time. Continuing the example, machine learning model 128B outputs estimated stoppage 262, a predicted increased or additional amount of stoppage time.

In some aspects, machine learning model 128B may output one or more predictions. For example, a machine learning model 128B may output a first prediction for the first half of the game and a second prediction for the second half of the game. In some cases, the first prediction may be generated based on actual stoppage time and the second prediction generated based on predicted stoppage time for the second half.

In some cases, the predicted additional stoppage time can be based on the initial stoppage time prediction. For example, if a stoppage time prediction is an additional 4 minutes, then the predicted additional stoppage time may be 1 minute.

In other cases, the predicted additional stoppage time output from machine learning model 128B or output to a user device may be based on a position in time (e.g. current time). For example, if a match is into the 3rd minute of stoppage time, then the output predicted additional stoppage time may be 1 minute from the 3rd minute onwards (for a total of 4 minutes).

At block 412, method 400 may in involve outputting the additional stoppage time. Continuing the example, stoppage time prediction system 200 may output estimated stoppage 262. For instance, stoppage time prediction system 200 can output estimated stoppage 260 to a display or transmit the estimated stoppage 260 to another device. As discussed above, stoppage time prediction system 200 may provide the predicted amount of stoppage time to another device such as client device 108 or a downstream entity. In an example, the output of the estimated stoppage 262 may be a report. In such an example, the report may include estimated stoppage 262 as well as a summary of the reasons for the estimated stoppage 262 based on the additional delay data and/or any other type of data such as tracking data or event data. As another example, one or more market predictions may be generated based on the estimated stoppage 262. The market predictions may be generated based on the estimated stoppage 262 and predicted events as determined in accordance with the techniques disclosed herein. The market predictions may include a numerical prediction of a sports event related value (e.g., score, passes, play types, scores by a player or team, etc.) that is a likelihood of a given sporting event or events reaching or not reaching that value (e.g., whether a score will be above or below the market prediction value).

Additional analytics may be performed based on predicted stoppage time and/or predicted increased stoppage time. For instance, based on stoppage time, an estimated number of additional goals or passes may be predicted.

FIG. 5 depicts a graph 500 of various estimations of a delay time for specific delay types, in accordance with an aspect. Graph 500 depicts various plots 540, 542, 544, 546, and 548 representing respective percentages of delay added as stoppage time 520 (y-axis) against delay lengths 510 (x-axis).

As can be seen, each plot 540, 542, 544, 546, and 548 represents a different delay group. Plot 540 represents a goal, plot 542 a substitution, plot 544 an injury, plot 546 a regular delay, and 548 a special delay. Each point within a given plot represents a bin within a group. A resulting proportion is calculated by performing a linear regression on the data points from the bins.

As can be seen, not all delay groups are handled in the same way. For instance, delays that contain a goal or a special delay that represents external interruptions are compensated with more stoppage time when those types of delays take a short amount of time. By contrast, regular delays such as goal kicks and throw-ins, have far less compensation. Injuries have the most compensation generally.

Further, stoppage time patterns vary hugely depending on the country and league in which a match is being played. The referees in a particular league may tend to give more or less stoppage time, or it could be more intricate, such as injuries not being compensated fairly. Accordingly, disclosed systems track various features on a per-league level (always on period level), including an amount of stoppage time given, how often zero stoppage time is given, a total time of delays, an expected total amount of delay compensation, and an amount of stoppage time given that cannot be attributed to delays (estimate). In some cases, the average for these quantities is tracked over a period of either 50 (short-term) or 380 (long-term) games.

However, oftentimes even a rolling window of fifty games may be too slow to properly adjust to changes in a league. Specifically, the start of season can signify a significant change in how stoppage time is awarded, for example due to new league rules. An example of this is the 2022 World Cup in Qatar where, pre-tournament, it was announced that more stoppage time would be given relative to stoppage time given in past tournaments. In this example, a rolling window of 50 games would be too slow to adjust in such a situation.

Accordingly, in some aspects, the environmental data may be updated as new information is available. According to an embodiment, to adjust to changes more quickly (e.g., at the start of a season), a Bayesian updating approach may be implemented. In some cases, a prior expectation of an average value from a previous season may used. Then, for the beginning of a new season, the Bayesian approach updates a prior understanding of the delay information for a particular tournament as more data is collected.

This approach may prevent overfitting to a low number of games played. In some cases, a Normal prior distribution can be used. If the observed data points fall outside of what is considered likely by this distribution, the posterior distribution can be adjusted. As such, the delay feature values will only adjust significantly a new pattern becomes known as compared to the previous season.

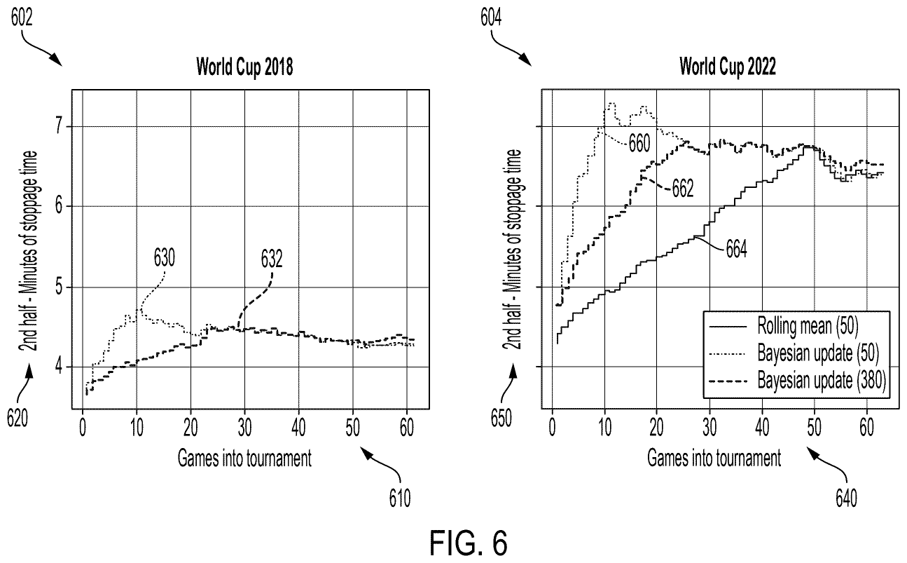

FIG. 6 depicts examples of a Bayesian updating stoppage time for various sporting events, in accordance with an aspect. Graphs 602 and 604 each represent examples of the Bayesian updating stoppage time feature for period two during the 2018 and 2022 World Cups. The data shown in graphs 602 and 604 may be considered environmental data 214 and therefore may be provided to machine learning models 128A-B.

Graph 602 depicts two plots 630 and 632, each indicating minutes of stoppage time 620 (y-axis) against number of games into a tournament 610 (x-axis). Similarly, graph 604 depicts plots 660, 662, and 664, each indicating minutes of stoppage time 650 (y-axis) against number of games into a tournament 640 (x-axis).

Plot 660 represents data associated with a Bayesian updated delay feature with windows size of 50 games. Plot 662 represents data associated with a Bayesian updated delay feature 380 games. By contrast, plot 664 represents data associated with a simple non-Bayesian 50-game rolling mean stoppage time for the 2022 World Cup. As can be seen, the use of a rolling mean in plot 660 means that the data of plot 660 becomes visible after game 50, when the rolling window has sufficient data points.

Stoppage time may vary by game, league, and/or competition. For instance, the 2022 World Cup saw an overhaul of how stoppage time was calculated by the refereeing teams, resulting in a large increase in average stoppage time in comparison to the 2018 data. In such cases, the Bayesian delay feature may be used to predict stoppage times. As can be seen, using this feature results in a new mean of around 6.5 minutes stoppage time being reached after only four games. By comparison, a simple rolling mean may take takes over forty games. This quicker convergence to a realistic feature value means that the Bayesian feature leads to more accurate predictions between game 4-40 in comparison to the rolling mean over the same game window. This is an improved feature value for over half the tournament.

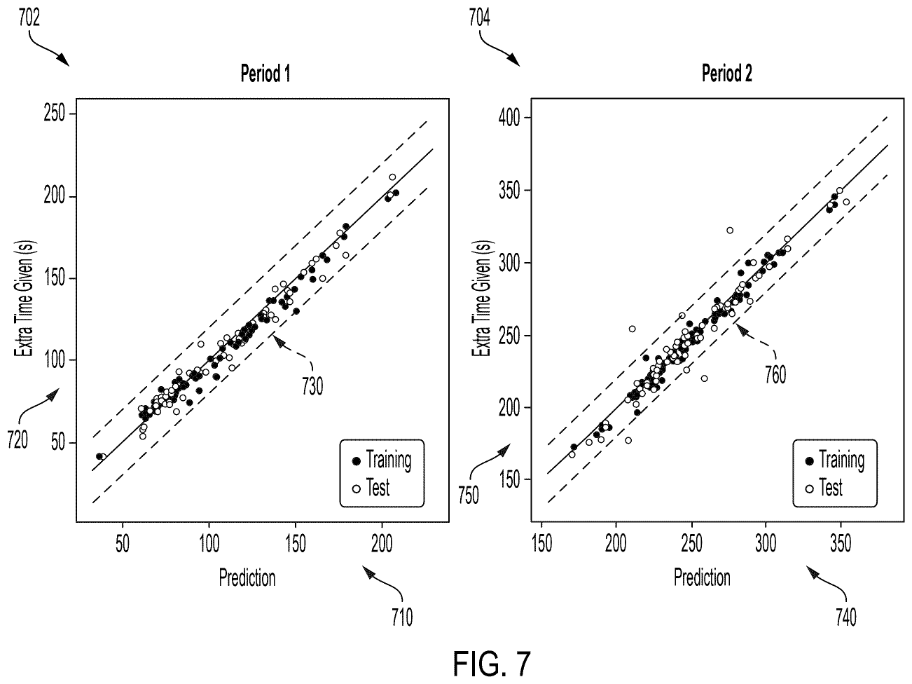

The machine learning models used herein may be calibrated from time to time. FIG. 7 depicts data used for calibration of machine learning model 128A.

FIG. 7 depicts data relating to calibration of a machine learning model for stoppage time prediction, in accordance with an aspect. FIG. 7 includes graphs 702 and 704. Graph 702 represents additional stoppage time predictions generated by the first model, machine learning model 128A, for a first period (e.g., half). More specifically, graph 702 depicts plot 730, which illustrates training data and test data points, each of which is plotted against actual minutes of stoppage time 720 (y-axis) against a prediction of minutes of stoppage time 710 (x-axis).

Graph 704 represents additional stoppage time predictions generated by the first model for a second period (e.g., half). Graph 704 depicts plot 760, which illustrates training data and test data points, each of which is plotted against actual minutes of stoppage time 750 (y-axis) against a prediction of minutes of stoppage time 740 (x-axis).

Each data point represents a single period of a single game, with features including the current total delay in seconds, expected delay in seconds based on the amount, length, and type of delays, historic league stoppage time information, and other data. The dotted lines represent a calibration error of 20 seconds.

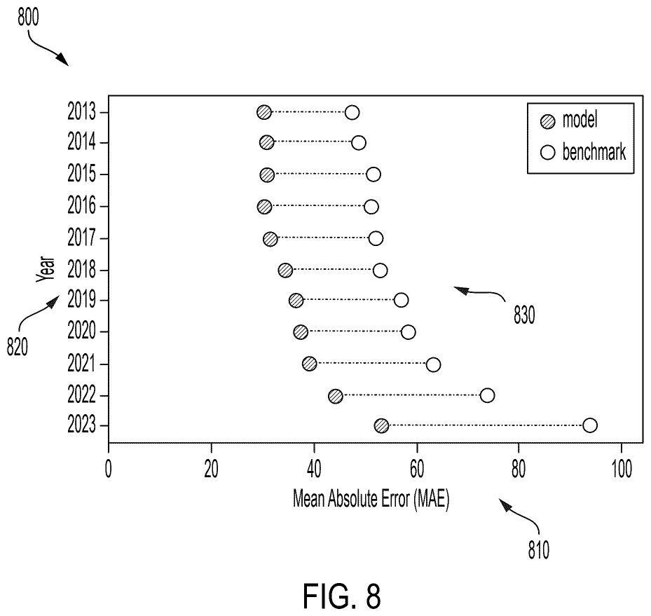

FIG. 8 depicts accuracy of a machine learning model for stoppage time prediction, in accordance with an aspect. Graph 800 includes various plots 830 each showing a respective variation between a model prediction (left) and a benchmark (right) of mean absolute error (x-axis) 810 versus year (820).

Machine learning models 128A-B are calibrated across both the training and test data as shown. As can be seen, the prediction accuracy is consistently superior relative to a benchmark model. The benchmark used is the average amount of stoppage time given in the relevant period, in the same league, over the last year. Note than a lower Mean Absolute Error (MAE) is better, but prediction accuracy is decreasing over time due to the average stoppage time being given increasing substantially.

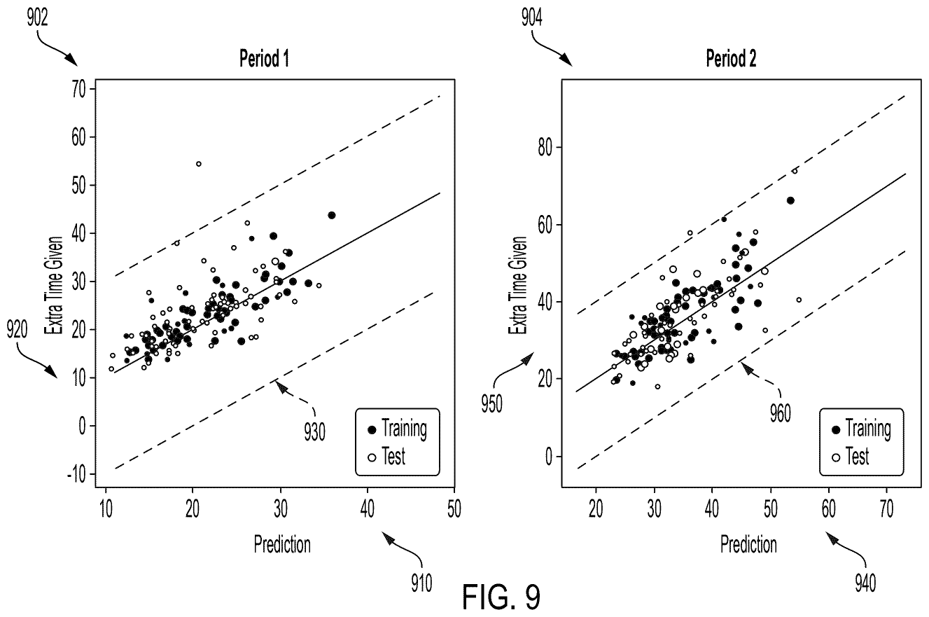

The machine learning models used herein may be calibrated from time to time. FIG. 9 depicts data used for calibration of machine learning model 128B.

FIG. 9 depicts a calibration of a machine learning model for additional stoppage time prediction, in accordance with an aspect. FIG. 9 includes graphs 902 and 904. Graph 902 represents additional stoppage time predictions generated by the second model, machine learning model 128B, for a first period (e.g., half), whereas graph 904 represents additional stoppage tie predictions generated by the second model for a second period (e.g., half).

More specifically, graph 902 depicts plot 930, which illustrates training data and test data points, each of which is plotted against actual minutes of stoppage time 920 (y-axis) against a prediction of minutes of stoppage time 910 (x-axis).

Similarly, graph 904 depicts plot 960, which illustrates training data and test data points, each of which is plotted against actual minutes of stoppage time 950 (y-axis) against a prediction of minutes of stoppage time 940 (x-axis). The dotted lines represent a calibration error of 20 seconds.

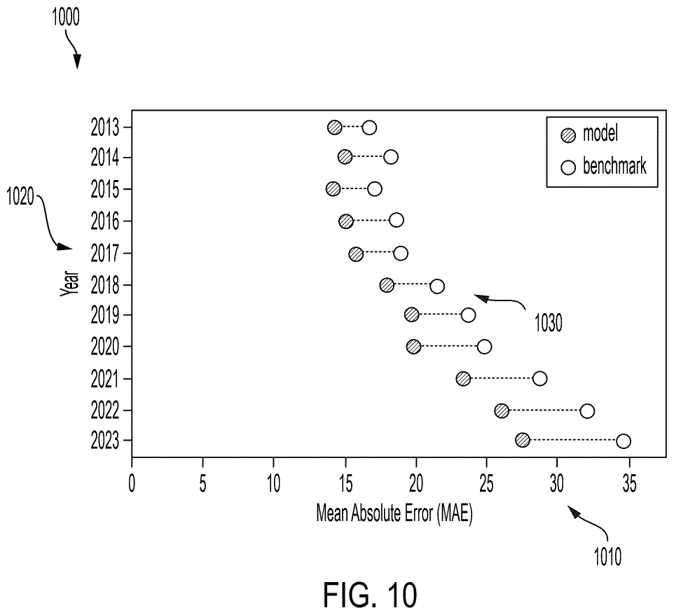

FIG. 10 depicts accuracy of a machine learning model for additional stoppage time prediction, in accordance with an aspect. Graph 1000 includes various plots 1030 each showing a respective variation between a model prediction (left) and a benchmark (right) of mean absolute error (x-axis) 1010 versus year (1020).

FIG. 10 depicts an accuracy of the second model used to predict additional stoppage time. As can be seen, the model shows an improvement relative to the benchmark.

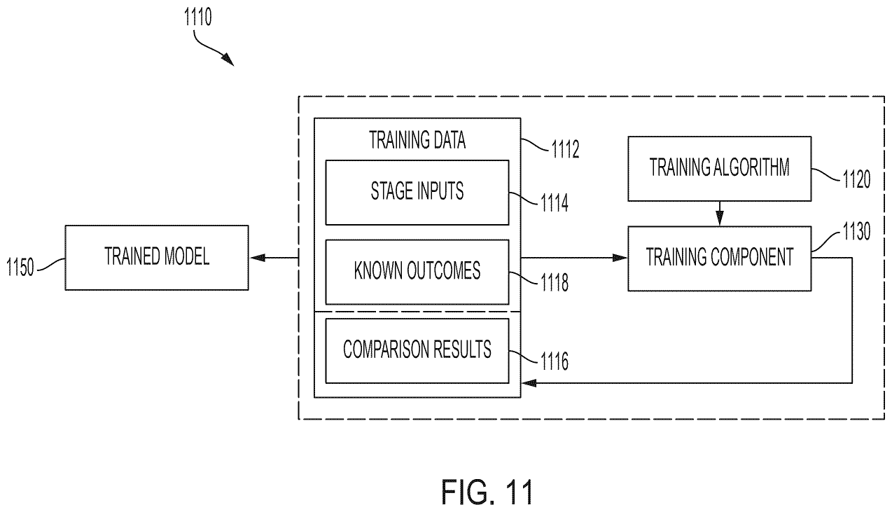

FIG. 11 depicts a flow diagram for training a machine learning model, in accordance with an aspect. As shown in flowchart 1110 of FIG. 11, training data 1112 may include one or more of stage inputs 1114 and known outcomes 1118 related to a machine learning model to be trained. The stage inputs 1114 may be from any applicable source including a component or set shown in the figures provided herein. The known outcomes 1118 may be included for machine learning models generated based on supervised or semi-supervised training. An unsupervised machine learning model might not be trained using known outcomes 1118. Known outcomes 1118 may include known or desired outputs for future inputs similar to or in the same category as stage inputs 1114 that do not have corresponding known outputs.

The training data 1112 and a training algorithm 1120 may be provided to a training component 1130 that may apply the training data 1112 to the training algorithm 1120 to generate a trained machine learning model 1150. According to an implementation, the training component 1130 may be provided comparison results 1116 that compare a previous output of the corresponding machine learning model to apply the previous result to re-train the machine learning model. The comparison results 1116 may be used by the training component 1130 to update the corresponding machine learning model. The training algorithm 1120 may utilize machine learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, and/or discriminative models such as Decision Forests and maximum margin methods, or the like. The output of the flowchart 1110 may be a trained machine learning model 1150.

A machine learning model disclosed herein may be trained by adjusting one or more weights, layers, and/or biases during a training phase. During the training phase, historical or simulated data may be provided as inputs to the model. The model may adjust one or more of its weights, layers, and/or biases based on such historical or simulated information. The adjusted weights, layers, and/or biases may be configured in a production version of the machine learning model (e.g., a trained model) based on the training. Once trained, the machine learning model may output machine learning model outputs in accordance with the subject matter disclosed herein. According to an implementation, one or more machine learning models disclosed herein may continuously update based on feedback associated with use or implementation of the machine learning model outputs.

It should be understood that aspects in this disclosure are exemplary only, and that other aspects may include various combinations of features from other aspects, as well as additional or fewer features.

In general, any process or operation discussed in this disclosure that is understood to be computer-implementable, such as the processes illustrated in the flowcharts disclosed herein, may be performed by one or more processors of a computer system, such as any of the systems or devices in the exemplary environments disclosed herein, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices disclosed herein. One or more processors of a computer system may be included in a single computing device or distributed among a plurality of computing devices. A memory of the computer system may include the respective memory of each computing device of the plurality of computing devices.

FIG. 12 is a simplified functional block diagram of a computer 1200 that may be configured as a device for executing the methods disclosed here, according to exemplary aspects of the present disclosure. For example, the computer 1200 may be configured as a system according to exemplary aspects of this disclosure. In various aspects, any of the systems herein may be a computer 1200 including, for example, a data communication interface 1220 for packet data communication. The computer 1200 also may include a central processing unit (“CPU”) 1202, in the form of one or more processors, for executing program instructions. The computer 1200 may include an internal communication bus 1208, and a storage unit 1206 (such as ROM, HDD, SDD, etc.) that may store data on a computer readable medium 1222, although the computer 1200 may receive programming and data via network communications.

The computer 1200 may also have a memory 1204 (such as RAM) storing instructions 1224 for executing techniques presented herein, for example the methods described with respect to FIGS. 3 and 4, although the instructions 1224 may be stored temporarily or permanently within other modules of computer 1200 (e.g., central processing unit 1202 and/or computer readable medium 1222). The computer 1200 also may include input and output ports 1212 and/or a display 1210 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed aspects may be applicable to any environment, such as a desktop or laptop computer, an automobile entertainment system, a home entertainment system, etc. Also, the disclosed aspects may be applicable to any type of Internet protocol.

It should be appreciated that in the above description of exemplary aspects of the invention, various features of the invention are sometimes grouped together in a single aspect, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed aspect. Thus, the claims following the Detailed Description are hereby expressly incorporated into this Detailed Description, with each claim standing on its own as a separate aspect of this invention.

Furthermore, while some aspects described herein include some but not other features included in other aspects, combinations of features of different aspects are meant to be within the scope of the invention, and form different aspects, as would be understood by those skilled in the art. For example, in the following claims, any of the claimed aspects can be used in any combination.

Thus, while certain aspects have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Operations may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A method for using machine learning to predict stoppage time in a sporting event, the method comprising:
accessing, in real time, delay data from a sporting event, wherein the delay data is categorized by a type of delay;
generating, from the delay data, a linear regression;
providing, to a machine learning model, the linear regression and environmental data, wherein the machine learning model is trained to predict an estimated stoppage time;
receiving, from the machine learning model, a predicted amount of stoppage time; and
outputting the predicted amount of stoppage time.

2. The method of claim 1, further comprising:
generating, from the delay data, an additional linear regression associated with an actual stoppage time;
providing, to an additional machine learning model, the additional linear regression, the environmental data, and the predicted amount of stoppage time, wherein the additional machine learning model is trained to predict an additional stoppage time;
receiving, from the additional machine learning model, an additional predicted amount of increased stoppage time; and
outputting the predicted amount of stoppage time.

3. The method of claim 1, further comprising:
accessing an indication of a start of stoppage time associated with the sporting event and an announced stoppage time;
generating, from the delay data, an additional linear regression associated with the announced stoppage time;
providing, to an additional machine learning model, the additional linear regression, the environmental data, and the announced stoppage time, wherein the additional machine learning model is trained to predict an additional stoppage time;
receiving, from the additional machine learning model, an additional predicted amount of increased stoppage time; and
outputting the predicted amount of stoppage time.

4. The method of claim 1, wherein the delay data comprises a plurality of delays, each of the plurality of delays having a respective type, the method further comprising categorizing the delay data by the type of delay and organizing the plurality of delays by type.

5. The method of claim 1, wherein the delay data comprises delays associated with events comprising one or more of: an offside pass, a free kick, an out, a corner, a goal, an issuance of a card, a start delay, and a provoking of an offside.

6. The method of claim 1, wherein the environmental data comprises a mean stoppage time of stoppage times of multiple games within a tournament.

7. The method of claim 6, further comprising generating the environmental data, the generating comprising:
accessing a plurality of data elements, each data element representing a stoppage time associated with a respective game at a respective point within the tournament; and
calculating the mean stoppage time across the plurality of data elements by using a Bayesian approach.

8. The method of claim 1, further comprising deriving, from the predicted amount of stoppage time, one or more of an estimated number of goals or passes associated with the sporting event.

9. A method for using machine learning to predict additional stoppage time, the method comprising:
accessing an indication of a start of stoppage time associated with a sporting event and an announced stoppage time;
accessing, in real time, delay data associated with the announced stoppage time, wherein the delay data is categorized by a type of delay;
generating, from the delay data, a linear regression;
providing, to a machine learning model, the linear regression, the announced stoppage time, and environmental data associated with the stoppage time;
receiving, from the machine learning model, a predicted additional stoppage time; and
outputting the predicted additional stoppage time.

10. The method of claim 9, wherein the delay data comprises a plurality of delays, each of the plurality of delays having a respective type, the method further comprising categorizing the delay data by the type of delay and organizing the plurality of delays by type.

11. The method of claim 9, wherein the environmental data comprises a mean stoppage time of stoppage times of multiple games within a tournament.

12. The method of claim 11, further comprising generating the environmental data, the generating comprising:
accessing a plurality of data elements, each data element representing a stoppage time associated with a respective game at a respective point within the tournament; and
calculating the mean stoppage time across the plurality of data elements by using a Bayesian approach.

13. The method of claim 9, further comprising deriving, from the predicted additional stoppage time, one or more of an estimated number of goals or passes associated with the sporting event.

14. A system for using machine learning to predict stoppage time in a sporting event, the system comprising:
a non-transitory computer readable medium configured to store processor-readable instructions; and
a processor operatively connected to the non-transitory computer readable medium, and configured to execute the instructions to perform operations comprising:
accessing, in real time, delay data from the sporting event, wherein the delay data is categorized by a type of delay;
generating, from the delay data, a linear regression;
providing, to a machine learning model, the linear regression and environmental data, wherein the machine learning model is trained to predict an estimated stoppage time;
receiving, from the machine learning model, a predicted amount of stoppage time; and
outputting the predicted amount of stoppage time.

15. The system of claim 14, wherein the processor is configured to execute additional operations comprising:
generating, from the delay data, an additional linear regression associated with an actual stoppage time;
providing, to an additional machine learning model, the additional linear regression, the environmental data, and the predicted amount of stoppage time, wherein the additional machine learning model is trained to predict an additional stoppage time;
receiving, from the additional machine learning model, an additional predicted amount of increased stoppage time; and
outputting the predicted amount of stoppage time.

16. The system of claim 14, wherein the processor is configured to execute additional operations comprising:
accessing an indication of a start of stoppage time associated with a sporting event and an announced stoppage time;
generating, from the delay data, an additional linear regression associated with the announced stoppage time;
providing, to an additional machine learning model, the additional linear regression, the environmental data, and the announced stoppage time, wherein the additional machine learning model is trained to predict an additional stoppage time;
receiving, from the additional machine learning model, an additional predicted amount of increased stoppage time; and
outputting the predicted amount of stoppage time.

17. The system of claim 14, wherein the delay data comprises a plurality of delays, each of the plurality of delays having a respective type and wherein the processor is configured to execute additional operations comprising categorizing the delay data by the type of delay and organizing the plurality of delays by type.

18. The system of claim 14, wherein the environmental data comprises a mean stoppage time of stoppage times of multiple games within a tournament.

19. The system of claim 18, wherein the processor is configured to execute additional operations comprising generating the environmental data, the generating comprising:
accessing a plurality of data elements, each data element representing a stoppage time associated with a respective game at a respective point within the tournament; and
calculating the mean stoppage time across the plurality of data elements by using a Bayesian approach.

20. The system of claim 14, wherein the processor is configured to execute additional operations comprising deriving, from the predicted amount of stoppage time, one or more of an estimated number of goals or passes associated with the sporting event.
